(19) United States
(12) Patent Application Publication
(10) Pub. No.: US 2003/0223737 A1
(43) Pub. Date: Dec. 4, 2003

(54) Video data recording method and video data recording apparatus

(75) Inventor: Manabu Shibutani, Yokohama-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/377,804

(22) Filed: Mar. 4, 2003

(30) Foreign Application Priority Data
May 31, 2002 (JP) 2002-160686

(51) Int. Cl. H04N 5/781

(52) U.S. Cl. 386/125; 386/126

(57) ABSTRACT

A video data recording apparatus of this invention includes a buffer having a capacity determined on the basis of information contained in video data to be recorded and a recording unit configured to record the video data at a predetermined recording destination through the buffer.

### CROSS-REFERENCE TO RELATED APPLICATIONS

This application is based upon and claims the benefit of priority from the prior Japanese Patent Application No. 2002-160686, filed May 31, 2002, the entire contents of which are incorporated herein by reference.

### BACKGROUND OF THE INVENTION

1. Field of the Invention

The present invention relates to a video data recording method and video data recording apparatus which record video data in real time.

2. Description of the Related Art

In recent years, recording apparatuses which record video data in real time have actively been developed. For example, a DVD recorder which records data based on the DVD-Video standard in real time on a DVD (Digital Versatile Disk) is known.

When data based on the DVD-Video standard is recorded in real time, future information ahead of a given time is necessary for making information of the given time. To do this, the DVD recorder must have a high-capacity buffer, or limit the record rate or record stop timing without if there is no buffer.

### BRIEF SUMMARY OF THE INVENTION

It is an embodiment of the present invention to provide a video data recording method and video data recording apparatus suitable to record video data in real time.

(1) Video data to be recorded by a video data recording method according to an aspect of the present invention contains a plurality of video title sets (VTSs), each of the video title sets contains a plurality of video objects (VOBs), each of the video objects contains a plurality of video object units (VOBUs), each of the video object units contains a navigation pack, the navigation pack contains video object unit information (VOBU_SRI) related to several video object units (1 to 15, 20, 60, 120, or 240 VOBUs) of the plurality of consecutive video object units (1, 2, 3, . . . , 238, 239, and 240 VOBUs). In the video data recording method according to an aspect of the present invention, the video data is recorded at a predetermined recording destination through a buffer having a capacity determined on the basis of the video object unit information.

(2) Video data to be recorded by a video data recording apparatus according to an aspect of the present invention contains a plurality of video title sets (VTSs), each of the video title sets contains a plurality of video objects (VOBs), each of the video objects contains a plurality of video object units (VOBUs), each of the video object units contains a navigation pack, the navigation pack contains video object unit information (VOBU_SRI) related to several video object units (1 to 15, 20, 60, 120, or 240 VOBUs) of the plurality of consecutive video object units (1, 2, 3, . . . , 238, 239, and 240 VOBUs) . The video data recording apparatus according to an aspect of the present invention comprises a buffer having a capacity determined on the basis of the video object unit information, and a recording unit configured to record the video data at a predetermined recording destination through the buffer.

Additional embodiments and advantages of the invention will be set forth in the description which follows, and in part will be obvious from the description, or may be learned by practice of the invention. The embodiments and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention and, together with the general description given above and the detailed description of the preferred embodiments given below, serve to explain the principles of the invention.

FIG. 1 is a view showing the data structure of a VTS contained in video data of a Video standard;

FIG. 2 is a view showing the data structure of a PGC (ProGram Chain);

FIG. 3 is a view showing the data structure of a VOBU;

FIG. 4 is a view showing the data structure of an NV_PCK;

FIG. 5 is a view showing the data structure of a PCI contained in the NV_PCK;

FIG. 6 is a view showing the data structure of a DSI contained in the NV_PCK;

FIG. 7 is a view showing the data structure of an SML_AGLI contained in the DSI;

FIG. 8 is a view showing the data structure of a VOBU_SRI contained in the DSI;

FIG. 9 is a view for explaining the reference destination by the reference address of the VOBU_SRI;

FIG. 10 is a view showing a video data recording apparatus which records video data;

FIG. 11 is a flow chart for explaining recording operation;

FIG. 12 is a flow chart for explaining cell end processing;

FIG. 13 is a view for explaining processing in stopping recording; and

FIG. 14 is a table showing the relationship between the number of VOBUs contained in one VOB (=one cell) and the buffer size (the number of VOBUS) determined on the basis of the VOBU_SRI.

### DETAILED DESCRIPTION OF THE INVENTION

An embodiment of the present invention will be described below with reference to the accompanying drawings.

A data structure based on the DVD-Video standard (referred to as Video standard hereinafter) will be described.

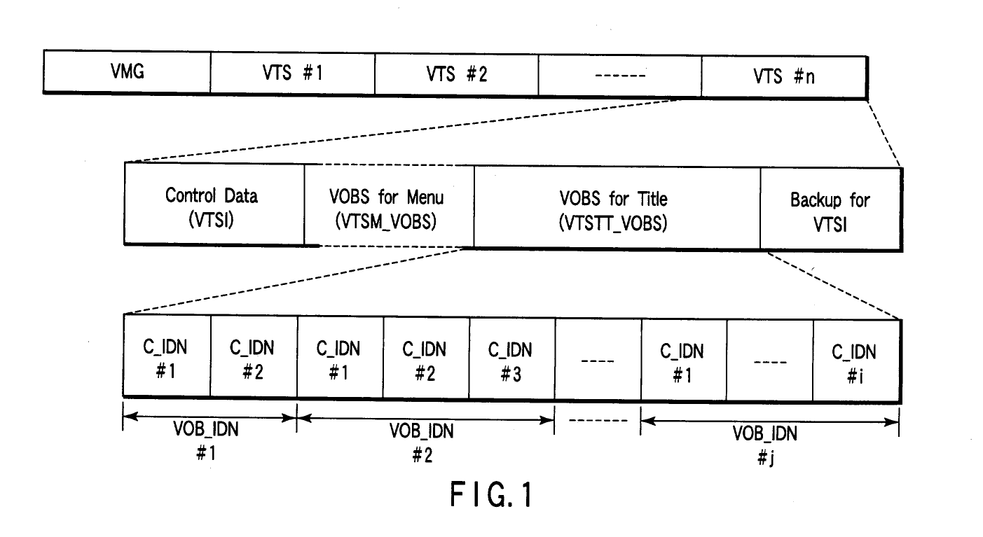

FIG. 1 is a view showing the data structure of a VTS contained in video data of Video standard. As shown in FIG. 1, the data structure of Video standard has one VMG (Video ManaGer) and a plurality of VTSs (Video Title Sets). The VMG contains the management information of the entire data structure or the information of a title menu. The VTS contains VTSI, VTSM_VOBS, VTSTT_VOBS, and VTSI_BUP. The VTSI is the management information of a title set. The VTSM_VOBS is the display information of the menu of the title set. The VTSTT_VOBS is the display information of the title set. The VTSI_BUP is the backup of the VTSI.

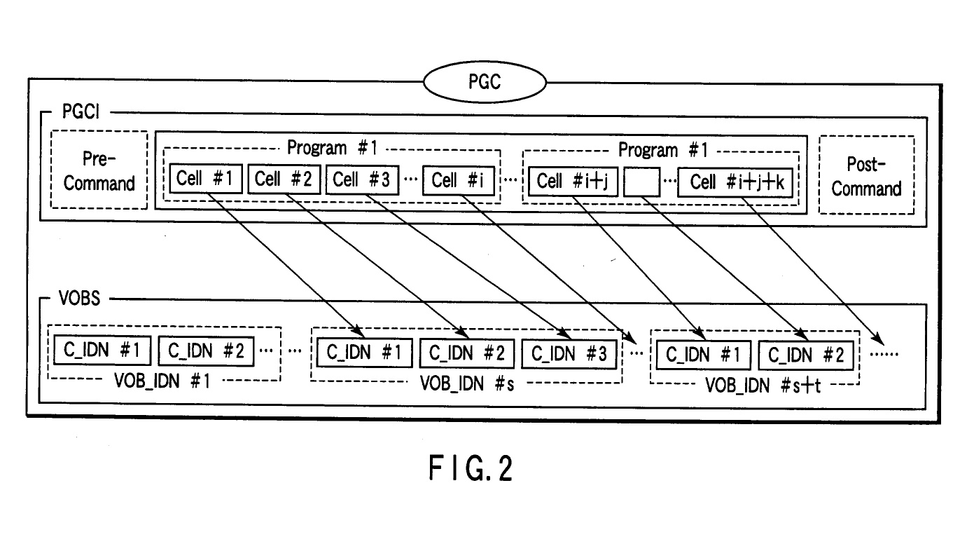

FIG. 2 is a view showing the data structure of a PGC (ProGram Chain). As shown in FIG. 2, a title is formed from at least one PGC. The PGC is formed from playback information to be referred to by a PGCI and cells in the VOB necessary for playback of the PGC. A PG (ProGram) is formed from several cells and used as a unit for random or shuffle playback or access by a command.

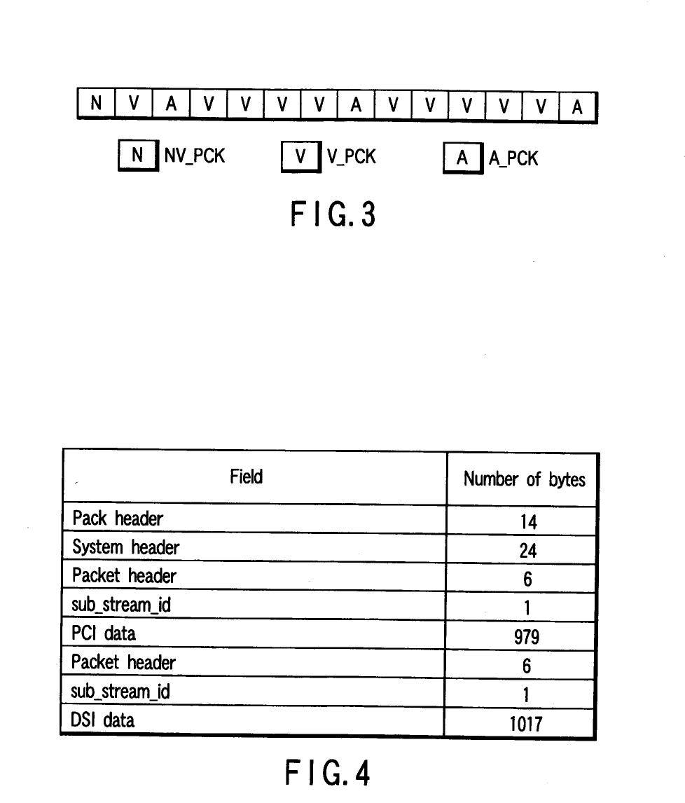

As shown in FIG. 1, a VOBS (Video OBject Set) contains display data and some pieces of management information. The VOBS is formed from a plurality of VOBs (Video OBjects). A VOB has a plurality of VOBUs (Video OBject Units). A VOBU is normally about 0.5-sec long display data. The VOBU is formed from NV_PCK, V_PCK, A_PCK, SP_PCK, and the like, as shown in FIG. 3.

FIG. 3 is a view showing the data structure of a VOBU. As shown in FIG. 3, an NV_PCK is always present at the start of a VOBU, where information about the VOBU is described.

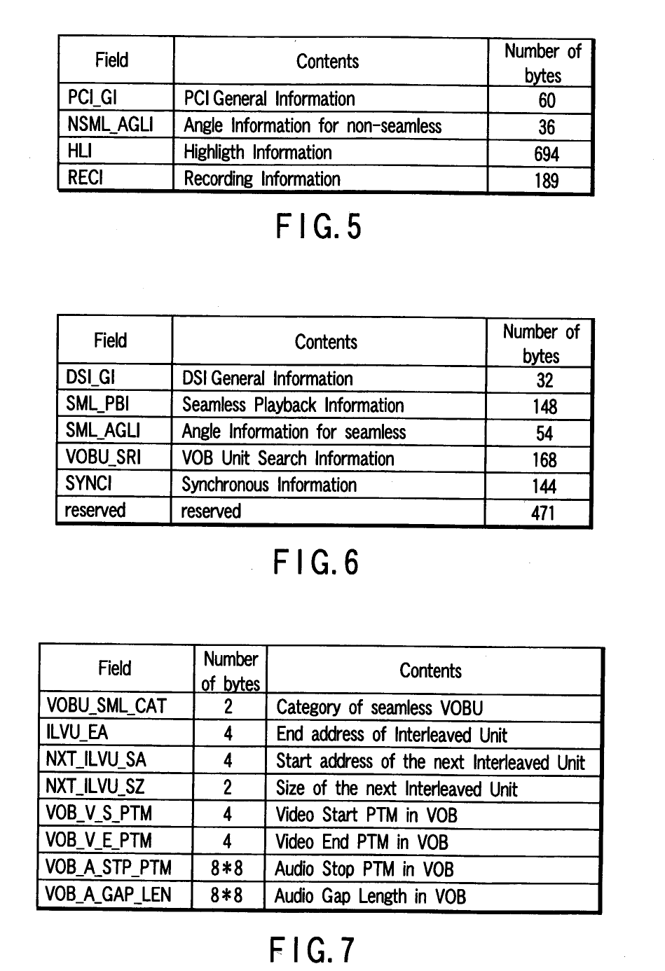

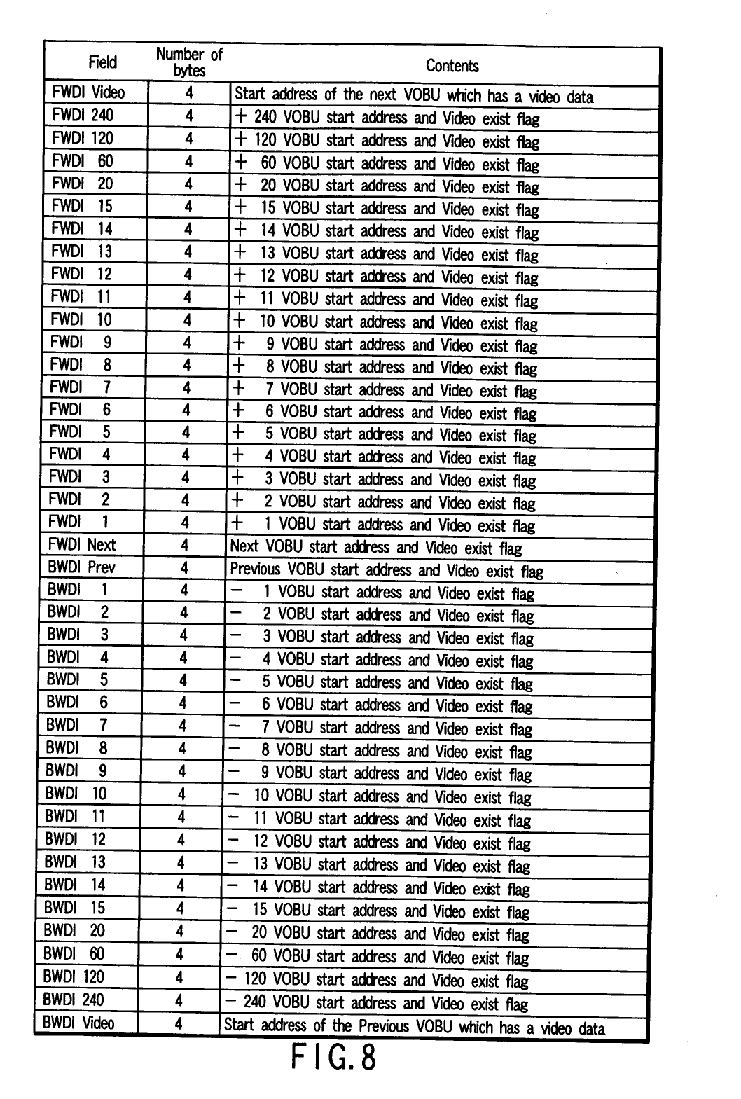

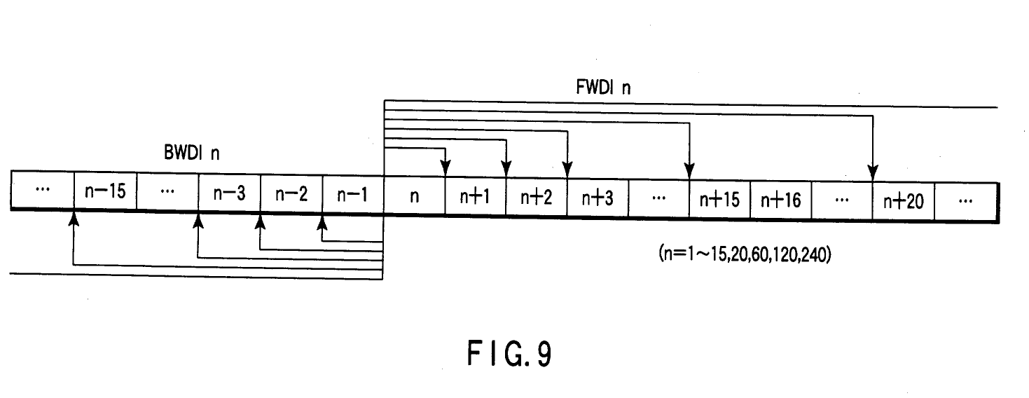

FIG. 4 is a view showing the data structure of an NV_PCK. FIG. 5 is a view showing the data structure of a PCI contained in the NV_PCK. FIG. 6 is a view showing the data structure of a DSI contained in the NV_PCK. FIG. 7 is a view showing the data structure of an SML_AGLI contained in the DSI. FIG. 8 is a view showing the data structure of a VOBU_SRI contained in the DSI. FIG. 9 is a view for explaining the reference destination by the reference address of the VOBU_SRI.

In the Video standard, real-time recording is not assumed at all. For this reason, an NV_PCK has some pieces of information that require the address of a pack to be generated after that NV_PCK, and the like. Examples of such information are the VOB_V_E_PTM contained in the SML_AGLI shown in FIG. 7 and the FWDIn contained in the VOBU_SRI shown in FIG. 8.

These pieces of information are recorded in real time while maintaining the consistency between the information by a method described below.

In the present invention, the following data are generated by, e.g., one cycle of recording from the start to the end of recording by the user. Assume that display data of one cycle of recording has one title. The data can be segmented into chapters by pause or at audio attribute change points.

As the data structure, one VTS is generated by one cycle of recording. One VTS contains one PGC. A plurality of VOBs are present in a VOBS. A VOB is formed from several VOBUs. If the number of VOBUs in the VOB is large, the buffer capacity must be large. If the buffer capacity is too small, the recordable time shortens. This is because the number of cells in one PGC must be 255 or less. Hence, the number of VOBUs in the VOB must appropriately be determined on the basis of the recording capacity of the medium serving as a recording medium.

The VOB basically has only one cell. However, the VOB sometimes contains a plurality of cells, depending on conditions. The conditions will be described later. The display data in one VOBU always has a playback time of 0.5 sec.

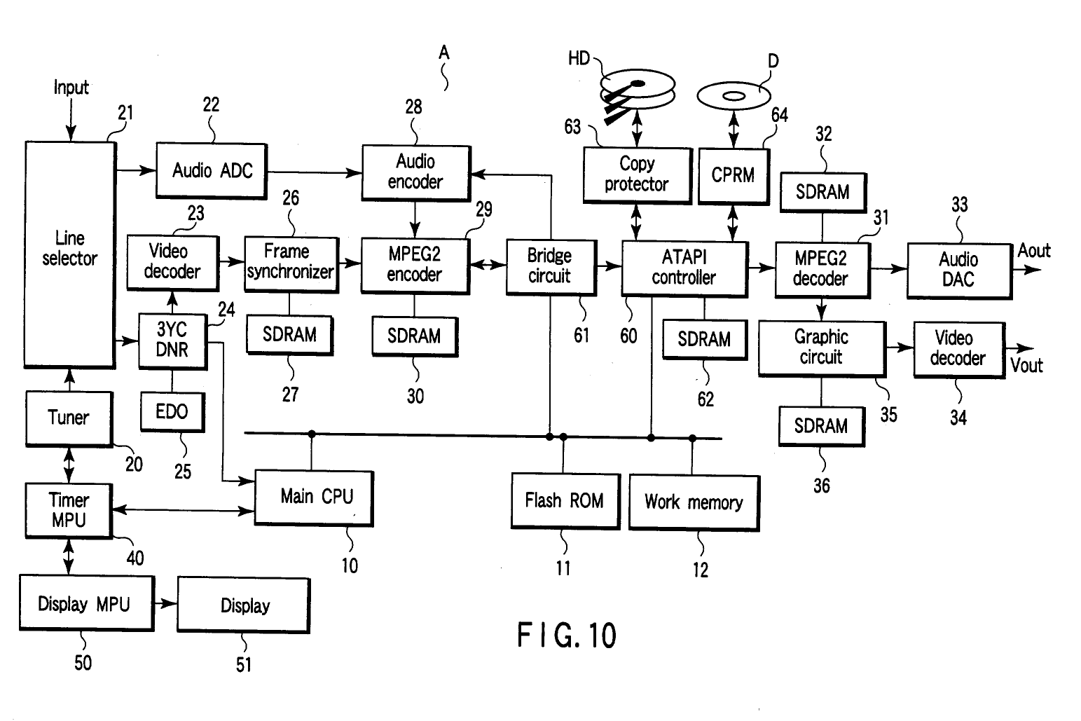

FIG. 10 is a view showing a video data recording apparatus which records video data. The video data recording apparatus formats video data in the DVD-Video standard data and records it on, e.g., an optical disk. The video data recording apparatus also plays back DVD-Video standard video data recorded on an optical disk. That is, the video data recording apparatus can be called an optical disk recording/playback apparatus.

As shown in FIG. 10, the optical disk recording apparatus comprises a main CPU 10, flash ROM 11, work memory 12, tuner 20, line selector 21, audio ADC 22, video decoder 23, 3YC DNR 24, EDO 25, frame synchronizer 26, SDRAM 27, audio encoder 28, MPEG2 encoder 29, SDRAM 30, MPEG decoder 31, SDRAM 32, audio DAC 33, video decoder 34, graphic circuit 35, SDRAM 36, timer MPU 40, display MPU 50, display 51, ATAPI controller 60, bridge circuit 61, SDRAM 62, copy protector 63, CPRM 64, and hard disk drive HD.

An analog input signal input from the tuner 20 or a line-in is converted into a digital signal through the line selector 21. The audio signal contained in the digital signal is input to the audio encoder 28. The video signal contained in the digital signal is input to the video encoder 29.

The video encoder 29 has a function of encoding a video signal in accordance with the MPEG (Moving Picture Expert Group) scheme defined by the Video standard and a function of receiving audio data encoded by the external audio encoder 28 and multiplexing the audio data and the encoded video data. The video encoder 29 is connected to the SDRAM 30 serving as a buffer for storing the multiplexed display data.

How the size of the SDRAM 30 is determined is described below. The size of the SDRAM 30 serving as a buffer is determined on the basis of the step value (n) of the VOBU_SRI (Video OBject Unit information) shown in FIG. 4.

As shown in FIG. 4, the VOBU_SRI in the NV_PCK contained in a predetermined VOBU contains the start addresses of VOBUs which are one, two, three, four, five, six, seven, eight, nine, 10, 11, 12, 13, 14, 15, 20, 60, 120, and 240 VOBUs ahead of the predetermined VOBU. The FWDIn (n=1 to 15, 20, 60, 120, 240) as future information is unknown before actual encoding because the size of each VOBU is not yet determined.

For example, assume that the maximum value of the number of VOBUs in the VOB is k, and the value k ranges from 1 to 15 (1≦k≦15) in association with the step (n) of the FWDI.

At this time, the buffer capacity (the size of the SDRAM 30) is given by

15×average bit rate (bit/sec)×maximum alienation ratio

In this case, the video encoder 29 stores up to 15 VOBUs in the SDRAM 30. The VOBUs stored in the SDRAM 30 are recorded in the hard disk drive HD through the bridge circuit 61, ATAPI controller 60, and copy protector 63.

Assume that the value k ranges from 20 to 59 (20≦k≦59) in association wit the step (n) of the FWDI.

At this time, the buffer capacity (the size of the SDRAM 30) is given by

20×average bit rate (bit/sec)×maximum alienation ratio

In this case, the video encoder 29 stores up to 20 VOBUs in the SDRAM 30. The VOBUs stored in the SDRAM 30 are recorded in the hard disk drive HD through the bridge circuit 61, ATAPI controller 60, and copy protector 63.

Assume that the value k ranges from 60 to 119 (60≦k≦119) in association wit the step (n) of the FWDI.

At this time, the buffer capacity (the size of the SDRAM 30) is given by

60×average bit rate (bit/sec)×maximum alienation ratio

In this case, the video encoder 29 stores up to 60 VOBUs in the SDRAM 30. The VOBUs stored in the SDRAM 30 are recorded in the hard disk drive HD through the bridge circuit 61, ATAPI controller 60, and copy protector 63.

Assume that the value k ranges from 120 to 239 (120≦k≦239) in association with the step (n) of the FWDI.

At this time, the buffer capacity (the size of the SDRAM 30) is given by

120×average bit rate (bit/sec)×maximum alienation ratio

In this case, the video encoder 29 stores up to 120 VOBUs in the SDRAM 30. The VOBUs stored in the SDRAM 30 are recorded in the hard disk drive HD through the bridge circuit 61, ATAPI controller 60, and copy protector 63.

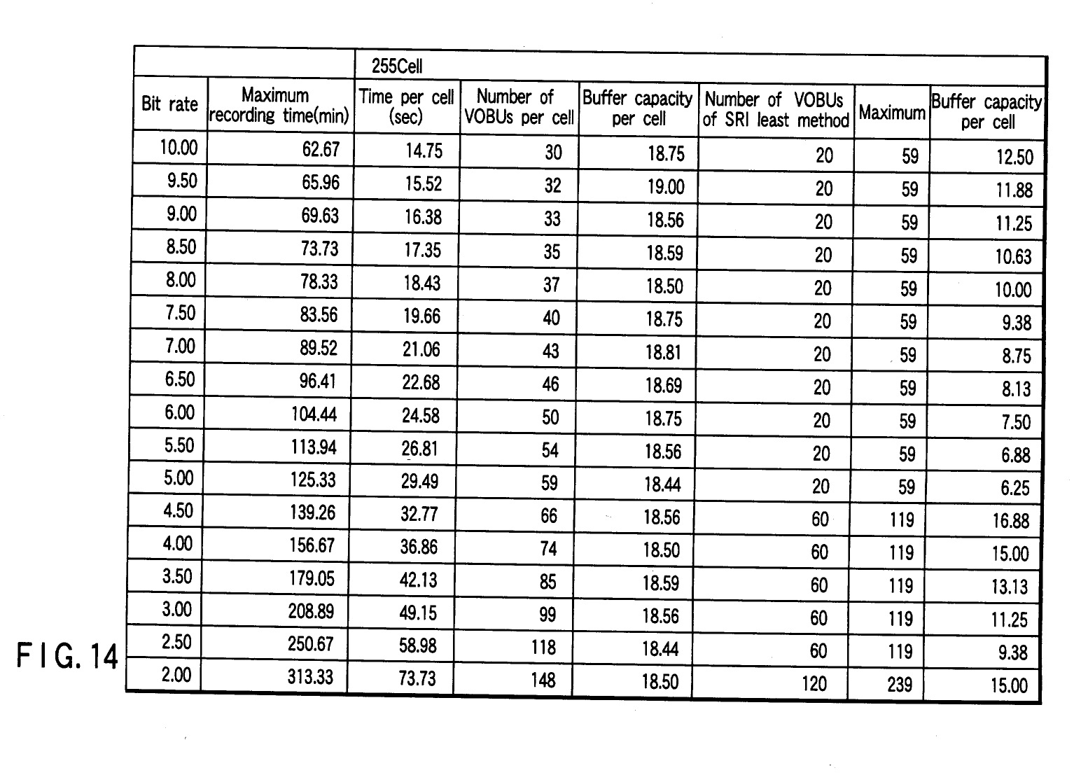

FIG. 14 is a table showing the relationship between the number (=k) of VOBUs contained in one cell (=one VOB) and the buffer size (the number of VOBUs) determined on the basis of the VOBU_SRI.

The average bit rate corresponds to the average value of data generation amounts per sec after multiplexing. The maximum alienation ratio corresponds to the maximum value of an instantaneous rate at which the data generation amount is more than the average bit rate.

As described above, when the buffer capacity is determined on the basis of the VOBU_SRI, the buffer capacity can be efficiently used without any waste. As a consequence, the buffer capacity can be decreased.

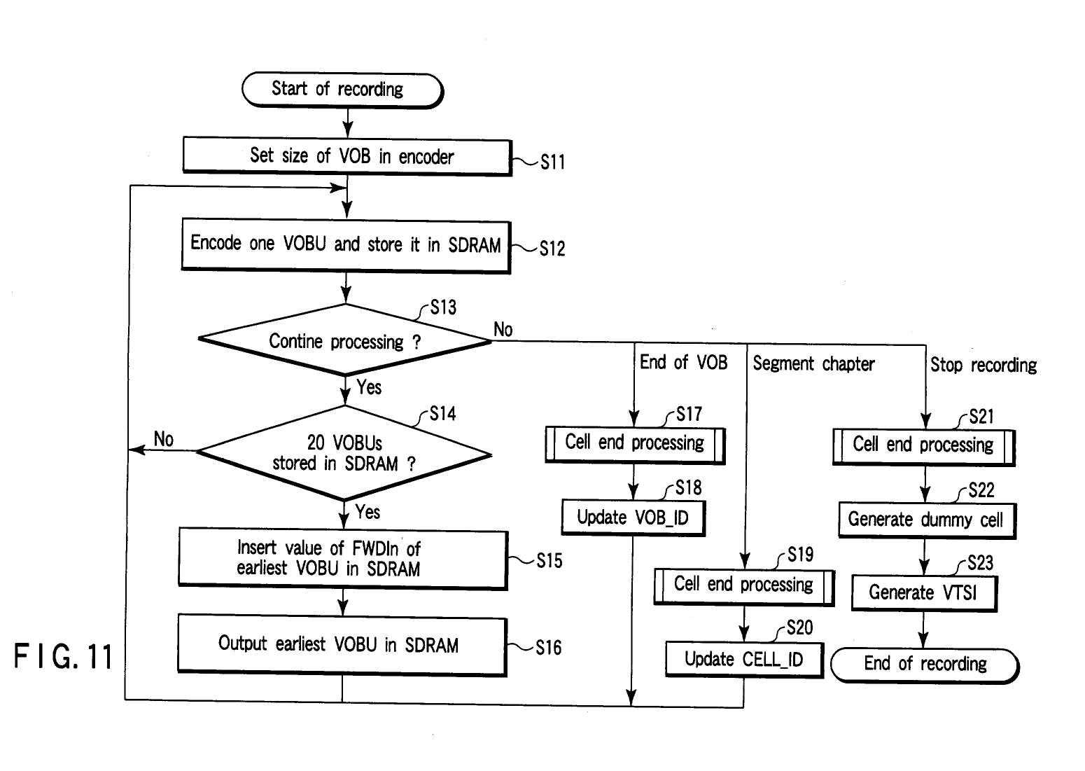

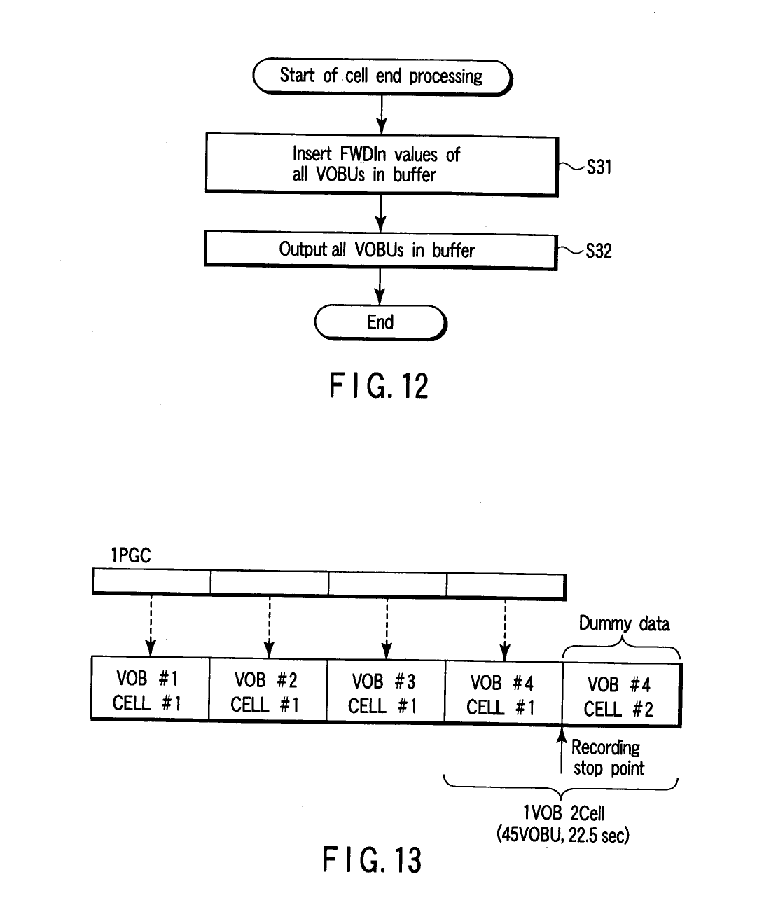

Processing from recording start operation to recording stop operation by the user will be described below with reference to FIGS. 11 and 12. FIG. 11 is a flow chart for explaining recording operation. FIG. 12 is a flow chart for explaining cell end processing. FIG. 11 is a flow chart for explaining processing in a case wherein up to 20 VOBUs are stored in the SDRAM 30 whose capacity is determined on the basis of the VOBU_SRI.

After the start of recording by the user, the video encoder 29 generates and outputs several VOBs. Before generation of a given VOB, the number of VOBUs to be contained in that VOB is determined in advance.

All VOBs in a VOBS may have an equal number of VOBUs. A pattern or the like (the number of VOBUs may be changed between the VOBs) is set before the start of recording. Before generation of the given VOB, the number of VOBUs must be determined (S11). When the number of VOBUs in the VOB is determined, the VOB_V_E_PTMs of NV_PCKs in all the VOBUs of the VOB are determined on the assumption that 1 VOBU=0.5 sec. Accordingly, VOBUs whose NV_PCK values are determined can be output before all VOBs are encoded. Hence, at the time of generating an NV_PCK, the value of the VOB_V_E_PTM can be inserted (S12).

The video encoder 29 starts encoding and stores, e.g., up to 20 VOBUs in the SDRAM 30 (S13, YES) (S14). Of the stored VOBUS, a VOBU encoded at the earliest time is selected as a target VOBU. FWDI1 to FWDI15 and FWD20 indicated by the VOBU_SRI in the NV_PCK contained in the target VOBU are referred to. VOBUs (15 +1 VOBUs) indicated by the FWDI1 to FWDI15 and FWD20 are also stored in the SDRAM 30. That is, the size of each of the VOBUs (15 +1 VOBUs) indicated by the FWDI1 to FWDI15 and FWD20 is calculated (S15).

The number of VOBUs in the VOB is determined in advance. The number of VOBUs in the VOB does not exceed 60. Hence, in each VOBU in the VOB, a value representing that no VOBU is present is inserted into information from FWDI60 of the VOBU.

When the values of the NV_PCKs in all the VOBUs are determined, the NV_PCKs are output from the buffer (S15). That is, the NV_PCKs of the VOBUs are recorded.

At the end of the VOB, the processing shifts to cell end processing (S17). More specifically, as shown in FIG. 12, not-yet-determined values are inserted for the NV_PCKs of all VOBUs in the buffer and output (S31 and S32). Subsequently, a VOB whose VOB_ID is updated (+1) is generated (S18).

Processing for segmenting data into chapters at an arbitrary portion by pause or a change in attribute of audio data will be described next.

A point between chapters must be a point between cells. Assume a case wherein cells are segmented when a given VOB is being encoded. The size of the VOB is already determined. Hence, the cell ID is updated midway in the VOB to segment the cells. The reference destination of the address described in the VOBU_SRI is limited in a predetermined cell. Hence, a VOBU stored in the SDRAM 30 is defined as a preceding cell, and the VOBU_SRI is determined and output (S31 and S32). The cell ID is updated (+1) from the next VOBU, and encoding is performed (S18).

That is, when a chapter segmentation point is to be set for one VOB, a plurality of cells belonging to one VOB are generated on both sides of the chapter segmentation point. More specifically, the MPEG2 encoder 29 executes chapter segmentation processing in correspondence with a chapter segmentation instruction to generate a plurality of cells belonging to one VOB. Accordingly, a chapter point can be designated in an arbitrary VOB.

Processing in stopping recording will be described next with reference to FIG. 13.

The number of VOBUs in a VOB is determined. Hence, as in the chapter segmentation processing, when the user performs stop operation, the cell ID is updated to segment cells.

VOBUs up to those stored in the SDRAM 30 are defined as one cell. The VOBU_SRI is determined and output (S31 and S32).

After that, if the number of VOBUs in the VOB, which is already determined, is not satisfied, the VOB must be completed. To do this, a dummy cell is inserted (S22).

The dummy cell is a group of VOBUs, in each of which the display time is 0.5 sec and the value in the NV_PCK satisfies the Video standard. After stop recording, the PGC in the VTSI is generated (S23). The PGC sequentially contains cells formed by this recording processing but not the last dummy cell. Hence, in the playback mode, the video data is played back only up to the point where the user has instructed stop.

That is, when recording stops midway in one VOB in correspondence with a recording stop operation, a plurality of cells belonging to one VOB are generated on both sides of the recording stop point. Dummy data is recorded in a cell in which the target video data is not recorded, thereby completing the recording stop operation. In addition, a program chain excluding the cell with the dummy data is generated. More specifically, the MPEG2 encoder 29 generates a plurality of cells belonging to one VOB on both sides of the recording stop point in correspondence with a recording stop instruction, records dummy data in a cell in which no target video data is recorded and, generates a program chain which excludes the cells with the dummy data. Accordingly, when the recording stop instruction is received from the user, the end processing can immediately be started. In addition, the dummy data is not played back.

As described above, in recording video data in real time, i.e., generating data based on the DVD-Video standard, the VOBU_SRI and VOBU_V_E_PTM of the NV_PCK pose problems. The problem of the VOBU_V_E_PTM is solved by fixing the number of VOBUs in the VOB. When VOBUs whose VOBU_SRI values are determined are sequentially output on the basis of the number of VOBUs and the step of the VOBU_SRI in the VOB, the buffer capacity can be reduced. Accordingly, a video data recording method and video data recording apparatus which can suppress the capacity of a buffer for buffering future information without limiting the recording rate or recording stop timing can be provided.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A video data recording method of recording video data in real time, comprising:
recording the video data at a predetermined recording destination through a buffer having a capacity determined on the basis of video object unit information,
wherein the video data contains a plurality of video title sets,
each of the video title sets contains a plurality of video objects,
each of the video objects contains a plurality of video object units,
each of the video object units contains a navigation pack, and
the navigation pack contains the video object unit information related to several video object units of the plurality of consecutive video object units.

2. A method according to claim 1, wherein the video object unit information in the navigation pack contained in a predetermined video object unit contains start addresses of video object units which are one, two, three, four, five, six, seven, eight, nine, 10, 11, 12, 13, 14, 15, 20, 60, 120, and 240 video object units ahead of the predetermined video object unit.

3. A method according to claim 2, wherein when the maximum number of video object units contained in the video object is k, and 15≦k≦19, the buffer has a capacity determined on the assumption that 15 video object units should temporarily be stored at maximum.

4. A method according to claim 2, wherein when the maximum number of video object units contained in the video object is k, and 20≦k≦59, the buffer has a capacity determined on the assumption that 20 video object units should temporarily be stored at maximum.

5. A method according to claim 2, wherein when the maximum number of video object units contained in the video object is k, and 60≦k≦119, the buffer has a capacity determined on the assumption that 60 video object units should temporarily be stored at maximum.

6. A method according to claim 2, wherein when the maximum number of video object units contained in the video object is k, and 120≦k≦239, the buffer has a capacity determined on the assumption that 120 video object units should temporarily be stored at maximum.

7. A method according to claim 1, wherein before the video object is generated, the number of video object units to be contained in the video object is determined, and an end time of the video object is determined.

8. A method according to claim 1, wherein when a chapter segmentation point is set for one video object, a plurality of cells belonging to one video object are generated on both sides of the chapter segmentation point.

9. A method according to claim 1, wherein when recording stops midway in one video object in correspondence with recording stop operation, a plurality of cells belonging to one video object are generated on both sides of a recording stop point, and dummy data is recorded in a cell having no target data recorded, thereby completing the recording stop operation.

10. A method according to claim 9, wherein a program chain which excludes the cell having the dummy data recorded is generated.

11. A video data recording apparatus for recording video data in real time, comprising:
a buffer having a capacity determined on the basis of video object unit information; and
a recording unit configured to record the video data at a predetermined recording destination through the buffer,
wherein the video data contains a plurality of video title sets,
each of the video title sets contains a plurality of video objects,
each of the video objects contains a plurality of video object units,
each of the video object units contains a navigation pack, and
the navigation pack contains the video object unit information related to several video object units of the plurality of consecutive video object units.

12. An apparatus according to claim 11, wherein the video object unit information in the navigation pack contained in a predetermined video object unit contains start addresses of video object units which are one, two, three, four, five, six, seven, eight, nine, 10, 11, 12, 13, 14, 15, 20, 60, 120, and 240 video object units ahead of the predetermined video object unit.

13. An apparatus according to claim 12, wherein when the maximum number of video object units contained in the video object is k, and 15≦k×19, the buffer has a capacity determined on the assumption that 15 video object units should temporarily be stored at maximum.

14. An apparatus according to claim 12, wherein when the maximum number of video object units contained in the video object is k, and 20≦k≦59, the buffer has a capacity determined on the assumption that 20 video object units should temporarily be stored at maximum.

15. An apparatus according to claim 12, wherein when the maximum number of video object units contained in the video object is k, and 60≦k≦119, the buffer has a capacity determined on the assumption that 60 video object units should temporarily be stored at maximum.

16. An apparatus according to claim 12, wherein when the maximum number of video object units contained in the video object is k, and 120≦k≦239, the buffer has a capacity determined on the assumption that 120 video object units should temporarily be stored at maximum.

17. An apparatus according to claim 11, wherein before the video object is generated, the recording unit determines the number of video object units to be contained in the video object and determines an end time of the video object.

18. An apparatus according to claim 11, wherein when a chapter segmentation point is set for one video object, the recording unit generates a plurality of cells belonging to one video object on both sides of the chapter segmentation point.

19. An apparatus according to claim 11, wherein when recording stops midway in one video object in correspondence with recording stop operation, the recording unit generates a plurality of cells belonging to one video object on both sides of a recording stop point, and records dummy data in a cell having no target data recorded, thereby completing the recording stop operation.

20. An apparatus according to claim 11, wherein the recording unit generates a program chain which excludes the cell having the dummy data recorded.
